(19) United States
(12) Patent Application Publication
(10) Pub. No.: US 2005/0036492 A1
(43) Pub. Date: Feb. 17, 2005

(54) Method for redirecting a bearer connection (bearer redirect) for SIP/ SIP-T subscribers

(76) Inventors: Klaus Hoffmann, Munchen (DE); Markus Pauls, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/909,804

(22) Filed: Jul. 31, 2004

(30) Foreign Application Priority Data
Jul. 31, 2003 (DE) 10335149.3

(51) Int. Cl. H04L 12/56

(52) U.S. Cl. 370/395.2

(57) ABSTRACT

In the prior art, a bearer connection is redirected for SIP/SIP-T control units in the TALK state with the aid of the SIP/SIP-T message RE-INVITE. In the RINGING state, said SIP/SIP-T message is not permissible, however, which is why a redirect of the bearer connection cannot be carried out here. The invention solves this problem in that the redirecting SIP/SIP-T control unit requests control information about the exchange of SIP/SIP-T messages by the SIP/SIP-T control units of the new bearer connection that is to be redirected, and said information is made available to the other side, whereupon a new bearer connection is established between said SIP/SIP-T control units.

The invention relates to a method according to the preamble of claim 1.

More modern communications architectures provide a separation of call processing networks into call service-related units and the transport of service information (bearer control). This results in a separation of the setting up of a connection and setting up of a medium or bearer. In such architectures, the transmission of service information (through-connection of the service channel) can be achieved via various high-bit rate transport technologies such as, for example, ATM, IP or Frame Relay.

With a separation of such a kind, the telecommunications services currently routed in narrow-band networks can also be achieved in broadband networks. In such services, the subscribers are either connected directly (e.g. via a DSS1 protocol) or via switching centers that are configured as media gateway controllers (MGCs) (e.g. via the ISUP protocol). The service information itself is converted via media gateways (MGs) to the respective transport technology used.

The control of the media gateways is carried out by the respective media gateway controllers (MGCs) assigned thereto. To control the media gateways, the media gateway controllers use standard protocols, such as, for example, the MGCP protocol or the H.248 protocol. To communicate with each other, the media gateway controllers use a BICC (Bearer Independent Call Control) protocol standardized by the ITU, which is made up of a plurality of standardized protocols and consequently includes a protocol family.

Since the BICC protocol represents a further development of an ISUP protocol, the relevant parts are combined in a separate part, which is known as the Q.1902.x BICC CS2 protocol (bearer independent call control capability set 2, with its own service indicator in the MTP (message transfer part). The parts that are specific only to the communication between the media gateway controllers are set out in a further section that is known as Q.765.5 BAT (bearer application transport). The above ITU-T standard protocol also describes RTP as the bearer technology for IP bearers. Consequently, for transmission through the ATM or IP network, a separation is made between signaling information and service information, through which the end customer is provided with his usual services in the telecommunications network.

A protocol equivalent to the BICC protocol has been created in the IETF standardization committee with the RFC 3204 protocol (=SIP-T protocol). The above protocol constitutes an addition to the SIP protocol (RFC 3261). Unlike the SIP protocol, the SIP-T protocol can be used to transmit ISUP messages. The transmission of ISUP messages is generally achieved by tunneling, i.e. by transparent transmission. Preferably, the ISUP messages sent by a PSTN subscriber are transmitted together with a bearer message (INFO Method, RFC 2976) and directed to the receiving PSTN subscriber.

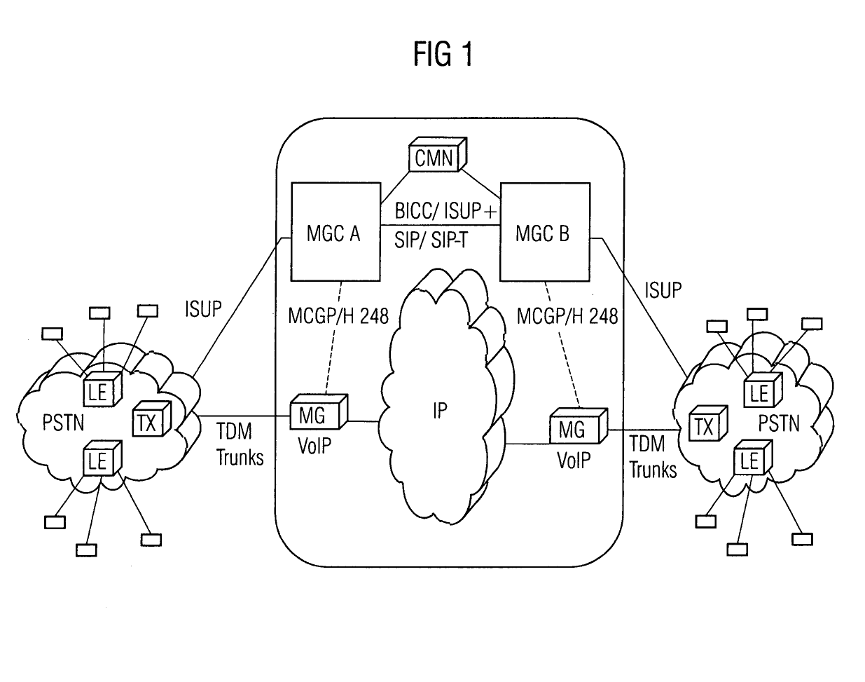

FIG. 1 shows a general network configuration according to the prior art, having TDM/IP networks. Here, for instance, 2 PSTN networks are disclosed, in each of which a plurality of PSTN subscribers are arranged in a known manner. Said subscribers are linked up to local exchanges LE, which in turn are connected to transit exchanges TX.

The separation between signaling information and service information is now achieved in the transit exchanges TX. The signaling information is supplied direct to the respective media gateway controller MGC (MGC A or MGC B) by the transit switching center TX via an ISUP protocol. The service information is transmitted to a media gateway MG (MG A or MG B) (arranged on the input side), which gateway functions as an interface between the TDM network and an ATM or IP transmission network, where it is transmitted via the relevant transmission network (ATM or IP) in a packet-oriented manner. The media gateway MG A is controlled by the media gateway controller MGC A, and the media gateway MG B is likewise controlled by the media gateway controller MGC B. In the case of a transmission of service information from the media gateway MG A to the media gateway MG B, the service information is converted into a TDM data stream, once again under the control of the media gateway controller MGC B that is assigned to the media gateway MG B, and supplied to the relevant PSTN subscriber.

The data transmitted between the media gateway controller MGC and the respective media gateway assigned thereto are supported by a standardized protocol. This can be the MGCP or the H.248 protocol, for example. Between the two media gateway controllers MGC A, MGC B, a BICC protocol, an SIP- or an SIP-T protocol can be provided as a further standardized protocol. Further devices such as proxies can also be connected between the two media gateway controllers.

It is basically desirable for various service features known from the TDM environment also to be used in the IP environment. As examples thereof, the service features “call forwarding”, “call transfer”, “queuing”, or “sequencing” might be mentioned. In all the above service features, redirection of the bearer connection is necessary. This means that an existing bearer connection between two SIP/SIP-T control units has to be redirected to a third SIP/SIP-T control unit. It is true that the processes standardized by the ITU/IETF allow the redirecting of a bearer connection to a third SIP/SIP-T control unit, if the call has been accepted (talk state). In this case, this process can be controlled by the SIP/SIP-T message RE-INVITE.

If, however, the bearer destination point data have already been exchanged in the course of the call set-up, but the call has not yet been answered (ringing state), a redirection of the bearer connection is not possible. The reason for this is that the required control message RE-INVITE is permissible only in the talk state and can be used here, but not in the ringing state.

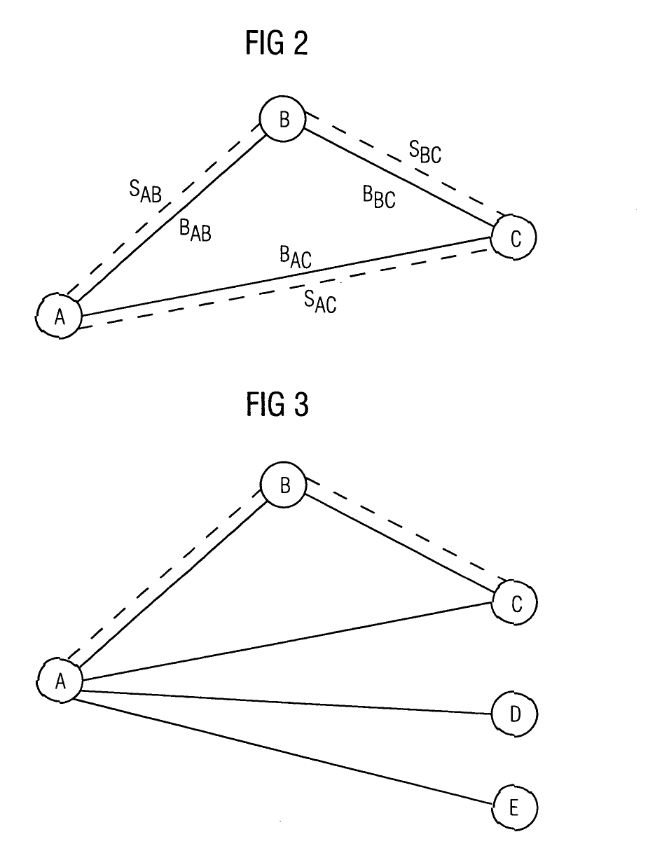

To clarify the above conditions, reference is made to FIG. 2, where the basic situation is explained using the example of the service feature “Call Transfer” in the IP network. Accordingly a configuration is shown that has SIP/SIP-T control units which are accustomed to communicate with one another. For example, FIG. 2 shows three SIP/SIP-T control units that are configured as subscriber terminals or subscribers A, B and C. As already disclosed in association with FIG. 1, the information sets from the service channel (bearer connection) and that from the signaling channel Internet IP are routed separately. Altogether, 3 service channels B_{AB}, B_{BC} and B_{AC} are shown in each case, exchanging information between the respective subscribers A, B, C. The signaling information is routed via signaling connections S_{AB}, S_{BC}, S_{AC} assigned to the service channels, which connections are shown as dotted lines in FIG. 2.

In the text that follows, it is now assumed that subscriber B is to transfer a call arriving from subscriber A to subscriber C (call transfer). Accordingly, subscriber A has first signaled a connection request to subscriber B. With the aid of the signaling channel S_{AB}, a service channel connection (bearer connection) B_{AB} has been set up with the aid of the SIP/SIP-T protocol. Subscriber B was informed of the forthcoming connection request of subscriber A, for example, by a ringing signal (alerting signal). As long as the ringing signal remained activated, both subscribers A, B were in a ringing state. The duration of the ringing state continued until B picked up the handset (accepted the connection request).

After the call has been accepted by B, both subscribers A and B are now in a talk state and can exchange information. Subscriber B would now like to let A speak to a further subscriber, C. Subscriber B for his part therefore transmits a connection request to subscriber C via the signaling connection S_{BC} with the aid of the SIP/SIP-T protocol. When the call is accepted by subscriber C, the service channel connection B_{BC} between B and C is set up and B can thus communicate with C. Subscriber B informs C that A desires a communications relationship with C. For this purpose, the IP port address and optionally Codec information is transmitted from C to B (RE-INVITE), who transmits said information direct to A (RE-INVITE). Thus a direct service channel connection B_{AC} can be set up between A and C. Whilst the two service channel connections B_{AB} and B_{BC} can be disconnected, the two signaling connections S_{AB}, S_{BC} are maintained and an additional direct signaling connection S_{AC} does not need to be set up.

As long as the call from B is not accepted by subscriber C, the communications relationship between subscribers B and C is in the ringing state. Since this can certainly take quite a long time, there is the problem that needless time elapses and the network is loaded for an unnecessarily long time. Redirecting in the ringing state is not possible, however, since the RE-INVITE message is not permissible in the ringing state. The same applies to the service features “Queuing”, or “Sequencing”.

The invention addresses the problem of finding a way to control the redirecting of a bearer connection even in the ringing state.

Taking as its point of departure the features set out in the preamble of claim 1, the invention solves the problem by using the features claimed in the characterizing part thereof.

The advantage of the invention is that SIP/SIP-T control units on the C side can be reached by any control units that carry out the call transfer in the ringing state. For billing reasons, it may be necessary here for subscriber B that the duration of the call be detected. This means that a software system pertaining to subscriber B has to remain in the call-signaling path to put this into effect. It could be the case here, for example, that subscriber B still wants to exchange a few words with C before he actually activates the transfer. It is also possible, however, that subscriber C has not picked up the handset immediately and that things are taking too long for subscriber B, who therefore activates the transfer while still in the ringing state. Furthermore, in the solution suggested above, SIP/SIP-T subscribers are offered the full call transfer service.

A further advantage of the invention is that on the A side, it is permissible for SIP subscribers, just as it is for current PSTN or mobile radiotelephone subscribers to listen to various recorded announcement sequences and input service data (PIN, etc) even for non-chargeable services with which the final subscriber on the B side has not yet registered. This is particularly significant because, according to current standards, by transmitting “answer” (subscriber has answered) the final ISDN/POTS range of features is negotiated and billing is set in motion, and restrictions result from the premature transmission of an artificial “answer”.

The invention is explained in more detail below, with reference to an embodiment shown in diagram form.

The figures show the following:

FIG. 1 the fundamental relationships between 2 PSTN-subscribers, between which an Internet network is arranged,

FIG. 2 the fundamental relationships between 3 SIP/SIP-T control units in an Internet network IP

FIG. 3 the fundamental relationships between 5 SIP/SIP-T control units in an Internet network IP

The invention as shown in FIG. 2 will be explained in more detail using a first embodiment. Here the redirection of a bearer connection using the service feature “Call Transfer” is described. The SIP/SIP-T control units A, B, C are configured as SIP/SIP-T subscribers A, B, C.

If the following extension of the SIP/SIP-T protocol is used, a transfer to subscriber C can be offered in the ringing state to the transferring subscriber (in the present case B). This is achieved by inserting a new header in the SIP/SIP-T control messages UPDATE or PRACK (to be sent here in a forward direction).

| | | | | | | | | | |
|---|---|---|---|---|---|---|---|---|---|
| new | where | enc. | e—e | ACK | BYE | CAN | INV | OPT | REG |
| SDP offer request | | | h | — | — | — | | — | m |

With the above “SDP offer request” header, the partner on the SIP side is requested to send a new SDP offer. According to the present embodiment, the SIP partner in the SIP method UPDATE is then expected to make his SDP offer. The requesting SIP side can then give back the SDP answer in the 200 OK. To fully support the Codec negotiation between subscribers A and C, it is a responsibility of the logic system at the redirection point to examine the contents of the two SDPs that have been received, to detect the CODECs that they have in common, and to select common Codecs in the two SDP answers that are to be sent.

Table 1 below shows the exchange of SIP/SIP-T messages from B's viewpoint according to the invention. For this purpose it is assumed that an incoming call from a subscriber A is to be redirected by a subscriber B to a subscriber C. It is further assumed that subscriber C does not accept subscriber B's call—or does not do so right away—and consequently there is no question of a call redirect with the aid of the message RE-INVITE during the ringing state.

First, therefore, subscriber B requests an SDP offer from subscriber C via the SIP/SIP-T protocol using a corresponding parameter (header) “SDP Offer request”. This follows the recognition of the need for redirection by subscriber B. Subscriber C quits the request with a 200 OK answer. This of course only applies if subscriber C supports the new service feature. After he has quit, subscriber C gives subscriber B his IP port address and also Codec information.

The above information is transmitted via the SIP/SIP-T protocol (Session Initiation Protocol). The UPDATE method can be used to transport the information.

Secondly, subscriber A receives at the same time a RE-INVITE request (without SDP) prompting him to make his SDP offer. Subscriber A then, according to protocol, makes his SDP offer to subscriber B with 200 OK in response to the RE-INVITE request. The IP port address/Codec information received is transmitted by B to the original subscriber A who is calling, with the aid of the ACK method (A and B are in the talk state). The IP port address/Codec-information received is supplied by B to subscriber C with the aid of 200 OK as an answer to the UPDATE method (B and C are in the ringing state). It is a responsibility of the logic system at the redirection point to examine the contents of the two SDPs that have been received, to detect the CODECs that they have in common, and to select common Codecs in the two SDP answers that are to be sent. Subsequently, a bearer connection can now be set up directly between subscriber A and subscriber C, since both subscribers now have knowledge of the IP port address and also Codec information for the respective other party. Thus subscriber B is then disconnected from the bearer connection, but the signaling connection from A to B and C is still active, as before.

TABLE 1

| SIP/SIP-T | |
|---|---|
| new SIP offer request header | need for redirection detected |
| 200 OK answer to the above method | other side supports the new feature |
| UPDATE/PRACK with SDP offer | IP address and IP port of C side |
| | received |
| 200 OK to UPDATE/PRACK with | IP address and IP port of C side |
| SDP answer | resource made available to A side. |

Table 2 below shows a further development of the method according to the invention. In the present embodiment, it has been assumed that subscriber A for example can set up a direct SIP/SIP-T connection to subscriber B. In practice, this is not always the case, however. Thus, for example, two transit nodes (intermediate nodes) can be arranged between subscribers A and B. Sometimes, however, the BICC protocol is used between the two transit nodes. This means that mapping of the relevant parts of the SIP/SIP-T protocol for the BICC protocol has to be carried out.

TABLE 2

| | BICC (corresponding to | |
|---|---|---|
| | Q.1902.6, bearer redirection | |
| SIP/SIP-T | procedure) | SIP/SIP-T |
| [symbol] | [symbol] | [symbol] |
| new SIP offer | APM Action Indicator: “Bearer | new SIP offer |
| request header | Redirect” | request header |
| | Bearer Redirect Indicators | |
| | “Redirect Forwards Request” + | |
| | “Redirect Bearer Release | |
| | Complete” | |
| [symbol] | no mapping required | [symbol] |
| 200 OK answer to | | 200 OK answer to |
| above method | | above method |
| [symbol] | [symbol] | [symbol] |
| UPDATE with | APM Action Indicator: | UPDATE with |
| SDP offer | “Bearer Redirect” - Bearer | SDP offer |
| | Redirect Indicators: | |
| | “Redirect Bearer Connected | |
| | Indication” | |
| | IP address of A side | |
| [symbol] | [symbol] | [symbol] |
| 200 OK to | APM - Action Indicator | 200 OK to |
| UPDATE with | “Connect Forward + | UPDATE with |
| SDP answer | Notification + selected | SDP answer |
| | Codec” IP address of B side | |
| | [symbol] | |
| | APM - Action Indicator | |
| | “Connected” | |

Finally Table 3 gives an overview of the procedures according to the invention from the viewpoint of the redirection point that is configured at subscriber B.

TABLE 3

| | BICC (in | | BICC (in | |
|---|---|---|---|---|
| SIP/SIP-T to | accordance with | | accordance with | |
| B side (side | Q.1902.6 bearer | Logic system at | Q.1902.6 bearer | |
| has already | redirection | redirection | redirection | SIP/SIP-T |
| answered) | procedure) | point | procedure) | to C side |
| [symbol] | [symbol] | Actuates | [symbol] | [symbol] |
| RE-INVITE | APM Action | redirect to | APM Action | new SIP |
| without SDP | Indicator: | both sides | Indicator: “Bearer | offer |
| offer | “Bearer | | Redirect” | request |
| | Redirect” | | Bearer Redirect | header |
| | Bearer Redirect | | Indicators | |
| | Indicators | | “Redirect Forwards | |
| | “Redirect | | Request” + | |
| | Forwards | | “Redirect | |
| | Request” + | | Bearer | |
| | “Redirect | | Release | |
| | Bearer | | Complete” | |
| | Release | | | |
| | Complete” | | | |
| | no mapping | | no mapping | [symbol] |
| | required | | required | 200 OK |
| | | | | answer to |
| | | | | the above |
| | | | | method |
| [symbol] | [symbol] | Here there is a | | |
| 200 OK answer | APM Action | wait, and | | |
| to the RE- | Indicator: | information has | | |
| INVITE with | “Bearer | to be stored. | | |
| SDP offer on | Redirect” - | Furthermore, C | | |
| B side | Bearer | could have | | |
| | Redirect | answered more | | |
| | Indicators: | quickly. Then | | |
| | “Redirect | the sequence of | | |
| | Bearer | successive | | |
| | Connected | messages is | | |
| | Indication” | inverted. | | |
| | IP address of A | | | |
| | side | | | |
| | | It is a | [symbol] | [symbol] |
| | | responsibility | APM Action | UPDATE/ |
| | | of the logic | Indicator: “Bearer | PRACK with |
| | | system at the | Redirect” - | SDP offer C |
| | | redirection | Bearer Redirect | side |
| | | point to | Indicators: | |
| | | examine the | “Redirect Bearer | |
| | | contents of the | Connected | |
| | | two SDPs that | Indication” IP | |
| | | have been | address of A side | |
| | | received, to | | |
| | | detect the | | |
| | | CODECs that | | |
| | | they have in | | |
| | | common, and to | | |
| | | select common | | |
| | | Codecs in the | | |
| | | two SDP answers | | |
| | | that are to be | | |
| | | sent. | | |
| [symbol] | [symbol] | | | |
| ACK to the | APM - | | | |
| 200 OK (to | Action | | | |
| the re- | Indicator | | | |
| INVITE) with | “Connect | | | |
| SDP answer of | Forward + | | | |
| C side | Notification + | | | |
| | selectedCodec” | | | |
| | IP address of C | | | |
| | side | | | |
| | | | [symbol] | [symbol] |
| | | | APM —Action | 200 OK to |
| | | | Indicator “Connect | UPDATE/ |
| | | | Forward + | PRACK with |
| | | | Notification + | SDP answer |
| | | | selected Codec” | |
| | | | IP address of B | of B side |
| | | | side | |
| | [symbol] | | [symbol] | |
| | APM - | | APM - | |
| | Action | | Action Indicator | |
| | Indicator | | “Connected” | |
| | “Connected” | | | |

Thus the two subscribers are also connected on the RTP bearer level. It should be taken into consideration that the transferring subscriber can also be any TDM 1ESS subscriber.

In FIG. 3 a second embodiment is explained. In this figure, the redirection of a bearer connection by means of the service features “Queuing”, or “Sequencing” is explained. Here, the SIP/SIP-T control unit A is intended to represent an SIP/SIP-T subscriber A from whom the connection request originates. Furthermore FIG. 3 shows the SIP/SIP-T control units B, C, D, E, which, according to the present embodiment, are configured as an IN service, that is as announcement services, for example. In certain cases a plurality of announcements have to be generated in succession in the correct sequence, before the required subscriber is reached. For this purpose it is necessary to redirect the bearer connection, which originally existed from subscriber A to the SIP/SIP-T control unit B (announcement box B), in a very specific sequence to the SIP/SIP-T control units C, D, E (announcement boxes C, D), in order finally to reach the SIP/SIP-T subscriber E.

According to the invention, provision is made, primarily by means of a special tag in a Provisional Response message, for the A side to be prompted to start a new SDP offer/answer cycle. The SDP data are then renegotiated within this offer/answer cycle. The special tag can be, for example, a redefined header or a special response code from the region 18x.

If the following extension of the SIP protocol is used, the queuing/sequencing service feature can be offered to the SIP/SIP-T telephone subscriber on the A side. This is achieved, for example, by inserting a new header in the Provisional Response Method:

| | | | | | | | | | |
|---|---|---|---|---|---|---|---|---|---|
| | where | enc. | e—e | ACK | BYE | CAN | INV | OPT | REG |
| SDP offer request | 1xx | | h | — | — | — | o | — | — |

With the above “SDP offer request” header, the partners on the SIP side are requested to send a new SDP offer. According to the invention, the SIP partner in the SIP method UPDATE (the PRACK method is also conceivable here) is then expected to make his SDP offer. The requesting SIP side in the 200 OK can then give the SDP answer in return.

If, in an SIP Proxy or another SIP unit, or in another SIP terminal, the need to connect the bearer connection to a new resource is detected after an SDP answer has already been exchanged before the 200 OK (INVITE), the procedure is carried out as shown in Table 4.

Initially a bearer connection is set up first of all from subscriber A to an SIP/SIP-T control unit B. In the course of the announcement to A, A transmits to the control unit C his IP port address and also further information for example, relating to the CODEC for control unit A, and requests control unit C's IP port address and CODEC information. The subsequent procedure is shown in Table 4.

TABLE 4
SIP/SIP-T

| | |
|---|---|
| 1xx (INVITE) | Need for redirect detected |
| SIP offer request header, | |
| UPDATE/PRACK with SDP | IP address and IP port of A side received |
| offer | |
| 200 OK to UPDATE/PRACK | IP address and IP port of the new B side |
| with SDP answer | resource is made available to the A side |

After quitting the 200 OK, the offer/answer cycle is concluded. A new cycle can optionally be activated. After the control units A, C have received IP port addresses and also CODEC information for the respective other side, a new bearer connection has been set up between A and C and the old bearer connection between A and B has been disconnected. The same method—as that described between A and B—can now be implemented in the control unit C. As a destination, a further bearer connection is set up between A and control unit D, where further announcements are transmitted to subscriber A. Finally a bearer connection is optionally set up to subscriber E.

Table 5 shows the procedures in the event that there are no pure SIP/SIP-T connections but some of the connections are routed with the aid of BICC protocols. In this case mapping has to be carried out between the SIP environment and the BICC environment.

TABLE 5

| | BICC (corresponding with | |
|---|---|---|
| | Q.1902.6, bearer redirection | |
| SIP/SIP-T | procedure) | SIP/SIP-T |
| [symbol] | [symbol] | [symbol] |
| 1xx (INVITE) | APM | 1xx (INVITE) |
| SIP offer request | Action Indicator: “Bearer | SIP offer request |
| header, | Redirect” | header |
| | Bearer Redirect Indicators | |
| | “Redirect Forwards | |
| | Request” + | |
| | “Redirect Bearer Release | |
| | Complete” | |
| [symbol] | [symbol] | [symbol] |
| UPDATE/PRACK | APM | UPDATE/PRACK |
| with SDP | Action Indicator: “Bearer | with SDP |
| offer | Redirect” - | offer |
| | Bearer Redirect Indicators: | |
| | “Redirect Bearer Connected | |
| | Indication” | |
| | IP address of A side | |
| [symbol] | [symbol] | [symbol] |
| 200 OK to | APM - | 200 OK to |
| UPDATE/PRACK | Action Indicator “Connect | UPDATE/PRACK |
| with SDP | Forward + Notification + | with SDP |
| answer | selected Codec” | answer |
| | IP address of B side | |
| | [symbol] | |
| | APM - | |
| | Action Indicator | |
| | “Connected” | |

1-6. (cancelled)

7. A method for redirecting a bearer connection for SIP/SIP-T control units, wherein
between the control units an internet network is arranged, wherein
a first bearer connection between at least two SIP/SIP-T control units is arranged, which connection can be redirected to at least one further SIP/SIP-T control unit, which results in a second bearer connection being set up, wherein
in the ringing state one of the SIP/SIP-T control units of the first bearer connection establishes to which further SIP/SIP-T control unit said connection is to be redirected, wherein
control information is requested by said redirecting SIP/SIP-T control unit via the exchange of SIP/SIP-T messages with the SIP/SIP-T control units of the second bearer connection that is yet to be established, and wherein
said information is made available to the respective other side, whereupon the second bearer connection is set up between said SIP/SIP-T control units.

8. The method according to claim 7, wherein the signaling connections are furthermore routed via the redirecting SIP/SIP-T control unit after the bearer connection has been redirected.

9. The method according to claim 7, wherein the control information is information relating to the IP-port addresses of the SIP/SIP-T control units and also information about the respective Codecs used here.

10. The method according to claim 8, wherein the control information is information relating to the IP-port addresses of the SIP/SIP-T control units and also information about the respective Codecs used here.

11. The method according to claim 7, wherein the SIP/SIP-T messages are configured as an SIP/SIP-T signaling element UPDATE or PRACK, an information element (SDP header request) being provided, which element requests the other side to transmit control information and whereupon a new SDP offer/answer cycle is started.

12. The method according to claim 8, wherein the SIP/SIP-T messages are configured as an SIP/SIP-T signaling element UPDATE or PRACK, an information element (SDP header request) being provided, which element requests the other side to transmit control information and whereupon a new SDP offer/answer cycle is started.

13. The method according to claim 9, wherein the SIP/SIP-T messages are configured as an SIP/SIP-T signaling element UPDATE or PRACK, an information element (SDP header request) being provided, which element requests the other side to transmit control information and whereupon a new SDP offer/answer cycle is started.

14. The method according to claim 7, wherein the SIP/SIP-T messages are configured as an SIP/SIP-T signaling element PROVISIONAL RESPONSE, with the aid of which the other party is requested to transmit control information and whereupon a new SDP offer/answer cycle is started.

15. The method according to claim 8, wherein the SIP/SIP-T messages are configured as an SIP/SIP-T signaling element PROVISIONAL RESPONSE, with the aid of which the other party is requested to transmit control information and whereupon a new SDP offer/answer cycle is started.

16. The method according to claim 9, wherein the SIP/SIP-T messages are configured as an SIP/SIP-T signaling element PROVISIONAL RESPONSE, with the aid of which the other party is requested to transmit control information and whereupon a new SDP offer/answer cycle is started.

17. The method according to claim 7, wherein in a case where a protocol other than the SIP/SIP-T protocol is used, the SIP/SIP-T messages and control information are converted to said protocol.

18. The method according to claim 8, wherein in a case where a protocol other than the SIP/SIP-T protocol is used, the SIP/SIP-T messages and control information are converted to said protocol.

19. The method according to claim 9, wherein in a case where a protocol other than the SIP/SIP-T protocol is used, the SIP/SIP-T messages and control information are converted to said protocol.

20. The method according to claim 11, wherein in a case where a protocol other than the SIP/SIP-T protocol is used, the SIP/SIP-T messages and control information are converted to said protocol.

21. The method according to claim 14, wherein in a case where a protocol other than the SIP/SIP-T protocol is used, the SIP/SIP-T messages and control information are converted to said protocol.

22. A method for redirecting a bearer connection for SIP/SIP-T control units, comprising:
establishing an Internet network between the control units;
providing a first bearer connection between at least two SIP/SIP-T control units;
determining in the ringing state by one of the SIP/SIP-T control units of the first bearer connection to which further SIP/SIP-T control unit said connection is to be redirected;
redirecting the first bearer connection to the further SIP/SIP-T control unit;
requesting control information by said redirecting SIP/SIP-T control unit via the exchange of SIP/SIP-T messages with the SIP/SIP-T control units of a second bearer connection that is yet to be established;
making available said information to the respective other side; and
setting up the second bearer connection between said SIP/SIP-T control units.
